(19) United States
(12) Patent Application Publication
(10) Pub. No.: US 2017/0200105 A1
(43) Pub. Date: Jul. 13, 2017

(54) SUPPLY MECHANISM RESPONSIVE TO POPULATION DENSITY AND TRAVEL DISTANCE

(71) Applicant: INTERNATIONAL BUSINESS MACHINES CORPORATION, Armonk, NY (US)

(72) Inventors: Jeremy R. Bassinder, London (GB); Raphael Ezry, New York, NY (US); Munish Goyal, Yorktown Heights, NY (US); Jorge A. Malibran, Nanuet, NY (US)

(21) Appl. No.: 14/990,859

(22) Filed: Jan. 8, 2016

(51) Int. Cl. G06Q 10/06; G06Q 30/02; G06F 17/30; G06Q 10/08

(52) U.S. Cl. CPC G06Q 10/06315; G06Q 10/087; G06Q 30/0202; G06F 17/30241

(57) ABSTRACT

Aspects provide for selective location of supplies of goods based on dynamic population density and travel distance metrics. Consumer population density forecasts are determined for different geographic locations as functions of distances to different events having different population amounts and geographic population locations. A geographic maximal density location point is determined between geographic locations of the different events and that is located at different distances from the locations of different events as a function of differences in respective consumer population density forecasts for the events, and closer to an event location with a higher consumer population density forecast relative to the location of another event. A quantity of goods is allocated to a supply site that is located at the maximal density location point in an amount selected to maximize a business value of the goods as a function of a population distribution of the maximal density location point.

### BACKGROUND

Population distribution within a city, portion thereof or other metropolitan area is highly dynamic and variable with respect to time. For example, the Borough of Manhattan, New York City, N.Y., U.S.A., contains variable amounts of residential and workforce populations at any given time. Manhattan is about 22.96 square miles in area, and in one study is estimated to contain approximately 4 million people on a typical weekday, 2.9 million on a weekend day, and 2.05 million during a weekday nighttime, swelling a base residential population of 1.6 million with transient visitors from surrounding counties, cities and towns, as well as travelers arriving via auto, bicycle, and mass transportation options.

### SUMMARY

In one aspect of the present invention, a computer-implemented method includes a processor determining consumer population density forecasts for different geographic locations as functions of distances to each of different events that occurring over a time period duration. Each of the events have different population amounts and geographic population locations. Locations are identified for different supply sites for goods desired by consumers within the events population amounts, each supply having a different geographic location. A geographic maximal density location point is determined between geographic locations of the different events and that is located at different distances from the locations of different events as a function of differences in respective consumer population density forecasts for the events, and closer to an event location with a higher consumer population density forecast relative to the location of another event. A quantity of the goods is allocated to a supply site that is located at the maximal density location point in an amount selected to maximize a business value of the goods as a function of a population distribution of the maximal density location point.

In another aspect, a system has a hardware processor in circuit communication with a computer readable memory and a computer-readable storage medium having program instructions stored thereon. The processor executes the program instructions stored on the computer-readable storage medium via the computer readable memory and thereby determines consumer population density forecasts for different geographic locations as functions of distances to each of different events that occurring over a time period duration. Each of the events have different population amounts and geographic population locations. Locations are identified for different supply sites for goods desired by consumers within the events population amounts, each supply having a different geographic location. A geographic maximal density location point is determined between geographic locations of the different events and that is located at different distances from the locations of different events as a function of differences in respective consumer population density forecasts for the events, and closer to an event location with a higher consumer population density forecast relative to the location of another event. A quantity of the goods is allocated to a supply site that is located at the maximal density location point in an amount selected to maximize a business value of the goods as a function of a population distribution of the maximal density location point.

In another aspect, a computer program product has a computer-readable storage medium with computer readable program code embodied therewith. The computer readable program code includes instructions for execution which cause the processor to determine consumer population density forecasts for different geographic locations as functions of distances to each of different events that occurring over a time period duration. Each of the events have different population amounts and geographic population locations. Locations are identified for different supply sites for goods desired by consumers within the events population amounts, each supply having a different geographic location. A geographic maximal density location point is determined between geographic locations of the different events and that is located at different distances from the locations of different events as a function of differences in respective consumer population density forecasts for the events, and closer to an event location with a higher consumer population density forecast relative to the location of another event. A quantity of the goods is allocated to a supply site that is located at the maximal density location point in an amount selected to maximize a business value of the goods as a function of a population distribution of the maximal density location point.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts a cloud computing node according to an embodiment of the present invention.

FIG. 3 depicts a computerized aspect according to an embodiment of the present invention.

FIG. 4 is a graphic illustration of a demand and pricing relationship according to an embodiment of the present invention.

FIG. 5 is a flow chart illustration of a device, method or process according to an embodiment of the present invention.

FIG. 6 is a flow chart illustration of another embodiment of a device, method or process according to the embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

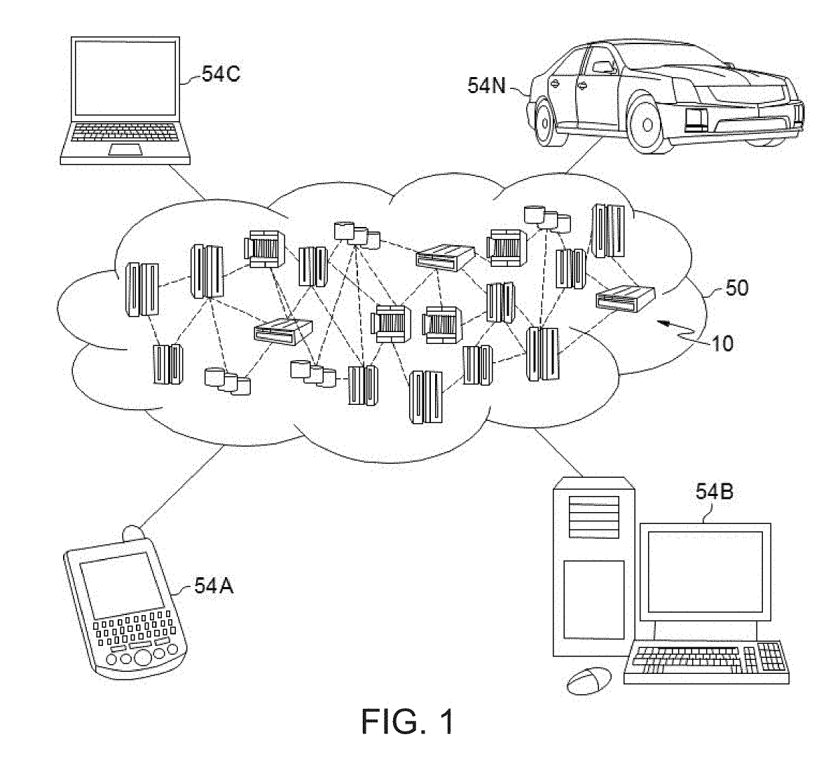

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

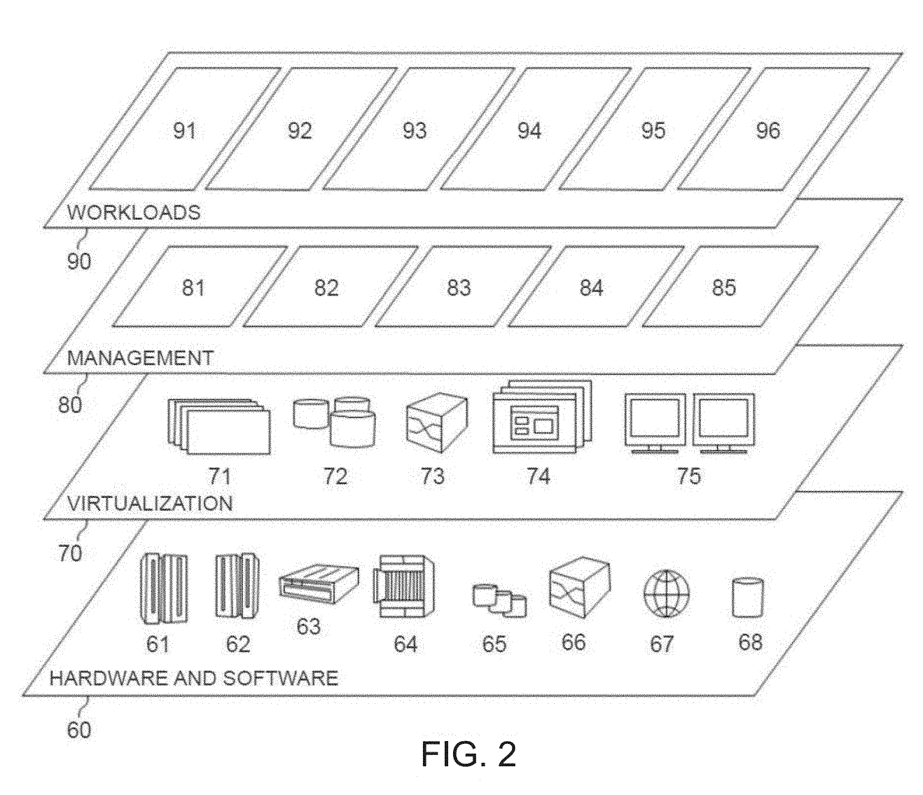

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 for the selective location of supply amounts based on dynamic population density and travel distance metrics, as described below.

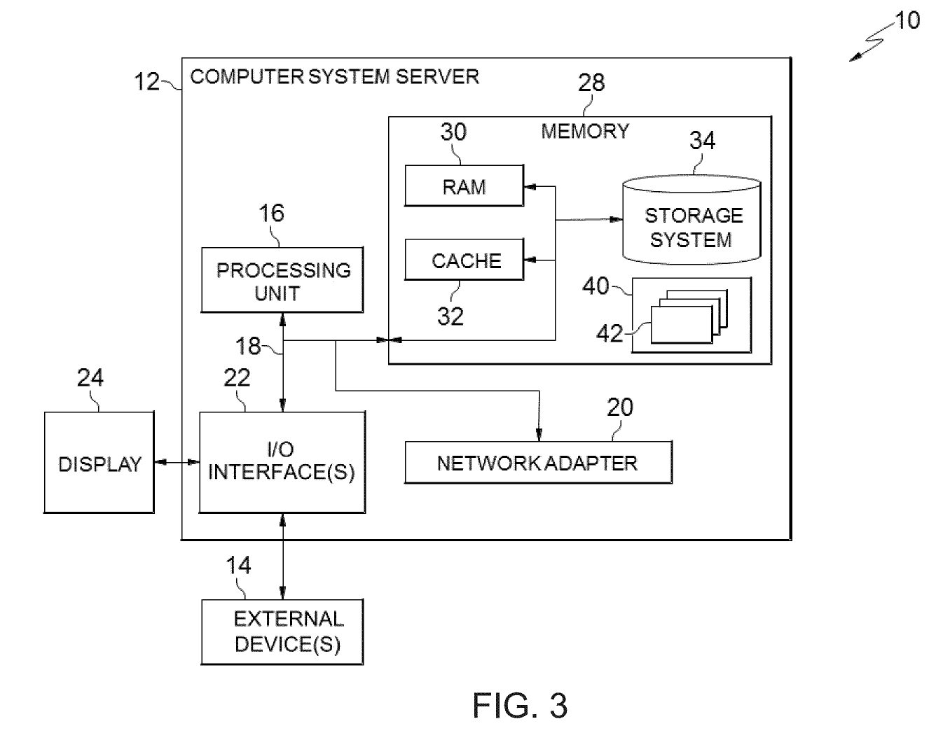

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Supply chain mechanisms that provide supplies of goods and services to metropolitan areas are generally static with respect to population flows through a metropolitan area, which may result in gaps between supply and demand metrics. This gap often creates temporal patches on a city's landscape where retailers cannot provide desired goods in sufficient quantities at the right time and the right price as a function of determined demand. Demand unmet due to mismatches between population densities and goods sought through demand metrics is often lost or unobserved. Aspects of the present invention provide advantages in better aligning and planning for provision of goods and services as a function of physical distance of the goods and service from the consumer, creating bases for goods and services with dynamic supply quantities that match or otherwise correlate to population flows through metropolitan areas.

In the interest of clarity and efficiency and to improve readability of the present specification, the term “goods” may be used generically herein to comprehend both goods and services that a consumer has a demand for, and that may be subject to trademark and trade dress identification as items that may be provided to a user or consumer in exchange for consideration (monetary, services, etc.).

Events may cause short-term opportunities to drive sales within areas populated by consumers. For example, a rainstorm may cause a spike in demand for umbrellas or rain ponchos among affected populations. However, as the weather may be constantly changing, or accurate predictions for rain may be limited to timeframes that are too short to adjust conventional supply chain systems, windows of opportunity may open and close too quickly to match a given supply to a current, dynamic demand under conventional supply chain systems and methods.

In contrast, aspects of the present invention dynamically vary locational attributes of the supply of goods or services with respect to a variety of time bases, to reduce the physical distance of goods from consumers and better match demand driven by transient events. Aspects may quickly vary supply amounts and locations for an hour of the day, a day of the week, a week of the month, a holiday or vacation period, or any timeframe of a city event having an identified population of consumers having a demand for a good. The timeframe durations may include duration of rainy weather or other weather patterns, duration of a trend in changing tastes or preferences of customers, etc.

In one aspect a demand function for a consumer good with a non-zero value of “α” is defined by the expression [1]:

D₁+α*D₂(e(t))−β*minimum(distance(demand,supply)) [1]

wherein “D₁” is a static or baseline demand value or price, and “D₂” represents a temporal volatility in demand that is positive (creates additional demand) or negative (diminished demand) as a function of a population of consumers identified or created by event “e” occurring at a certain time “t” in a city area (“(e(t)”). Illustrative but not exhaustive examples of the event “e” include weather events (periods of rain, snow, hail, sunshine, temperature values or ranges, storms, high winds, humidity values, cloud cover, etc., or combinations thereof), public assembly events (concerts, conventions, expos, sporting events, protests, races, etc.), holidays, scheduled sales events, etc.

In expression [1] the effective demand for a good is further reduced by “distance friction” relative to the consumer, via β*minimum(distance(demand, supply))”, wherein “β” is the cost of distance between a consumer location and the closest supply base, and “minimum(distance(demand, supply))” represents the distance of the closest available supply of the good to the consumer.

An observed demand may also be defined as a function of the expression [1] in expression [2]:

max(D₁+α*D₂(e(t))−β*minimum(distance(demand,supply)),0) [2]

In some transactions a physical distance separating a consumer from a desired, physical good must be overcome in order for the consumer to acquire the good, for example the consumer may have to drive, walk, take public transportation, etc., in order to physically enter a store offering a desired good for sale. Where traveling over the physical distance requires some amount of effort (energy) and/or money expenditure by the consumer, the demand value may diminish in relation to the amount of effort/expenditure required, and this diminishment may be referred to as “distance friction.”

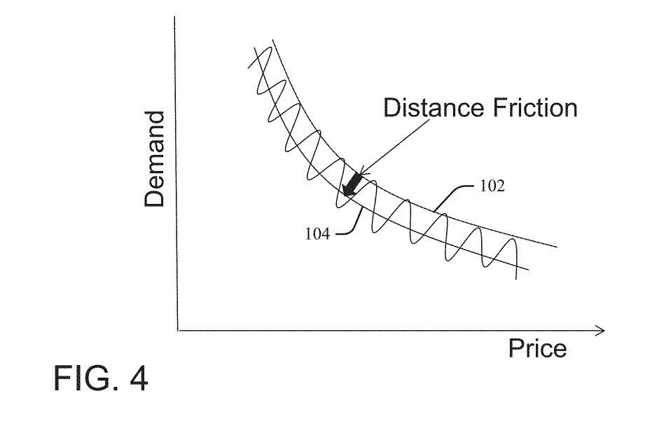

Thus, demand values, such as those determined by expressions [1] and [2], may define prices that a consumer is willing or likely to pay for goods as impacted by such distance friction. FIG. 4 is a graphical illustration of the relationship of price of a good to demand for the good by consumer. As price increases the demand decreases, and under the prior art a seller may use the relationship curve 102 to set pricing for a good to meet demand, for example, choosing lower pricing to increase sales, or higher pricing where demand outstrips supply. However, due to the effects of distance friction demand may actually be lowered over the relationship to price, as represented by the lower demand values for each price point indicated by alternative curve 104.

Due to distance friction, the distances that a consumer may be willing to travel or amount of time to expend before the efforts exceed the associated demand value for a given good may vary greatly, and the amount and intensity of the demand associated with the good acquisition may decay quickly as distance increases. Though no actual physical friction is involved, price and effort are metaphorically assumed to correspond to forces counteracting the will and desire of a consumer to engage in transport movements. The perceived distance friction may be a continuous, smooth function of distance, or it may contain jumps; it may be constant, linear or nonlinear or even a combination of jumps and proportional behavior, for example with different values for each of different intermodal freight or passenger transport legs or options that are combined to bring the consumer to the good.

Thus, distance frictions that exceed consumer demand values may prevent the consumer from acquiring the desired good, resulting in unmet temporal demand for goods, which in conventional prior art supply chain mechanisms is often unobserved and results in lost sales opportunities.

Conventional approaches seek to vary timeframes and costs in goods delivery, for example via online ordering and faster delivery of goods using drones. However, such mechanisms are not correlated with demand in response to dynamic population flows within city areas. In contrast, aspects of the present invention provide for systems and methods that dynamically minimize distances in correlation with temporal peaks in demand of identified population flows in defined areas, thereby maximizing and harnessing derived business value. Minimizing distances between demand and supply of goods may entail large costs, and aspects may limit these efforts to temporal time periods of high demand in order to realize enough sales revenue to offset the required costs.

Aspects of the present invention provide methods and systems for the selective location of supply amounts based on dynamic population density and travel distance metrics. Supply locations are filled with appropriate quantities of goods units dynamically as a function of capacity limitations, wherein amounts of different products may be simultaneously determined and managed at a given location to maximize expected sell value as function of identifying which goods are in demand, for which times, at which locations and at what volume.

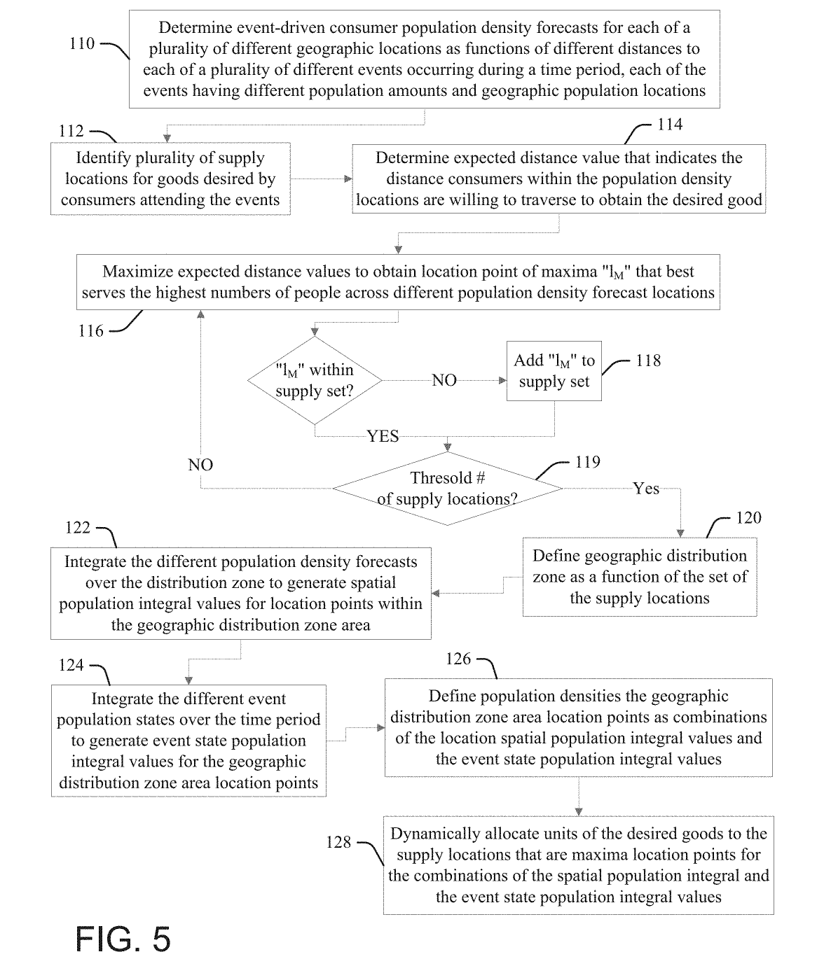

FIG. 5 is a flow chart illustration of one aspect of the present invention for supply unit deployment and zoning. At 110 a plurality of different one event-driven spatio-temporal population density forecasts (which may be notated as “P(l,t).”) are determined for two or more geographic locations “l” during a specific time period “t” during which a plurality of different event “e” occur. The population density forecasts are determined as functions of different distances to each of a plurality of different events occurring during a time period, wherein each of the events have different consumer population amounts and different geographic population locations.

Illustrative but not exhaustive examples of the geographic locations “l” include street addresses or ranges of addresses, global positioning satellite (“GPS”) coordinates or range of coordinates, etc. The population density value at each of the locations “l” may be predicted total occupancy (for example, one thousand people, 500 people, etc.) at the event locations, or density values (for example, one person per square foot for “x” square feet of occupancy space, or one person per 9 square feet for said space), etc. Various methods may used to project the population density values, including historic data for the location or type of location for an event similar to one of the events during the time period, or as indicated from another location; advanced ticket sales for each or similar events; historic population flow data over time for regions including the locations “l” during the time of the events, etc. The events each have their own time durations that occur within the time period “t”. Their time durations may or may not overlap, in whole or part, during the time period.

At 112 a set “S” of different supply locations “sₙ” locations are identified or determined for one or more (“n”) goods “g” (products, services, etc.) desired by consumers attending the events, wherein each location has a different location “l” value, and wherein the set may be notated as “S={s₁,s₂,s₃, . . . ,sₙ}.”

At 114 an expected distance value or metric is determined for the good that indicates the distance that the consumers within the determined population density locations are willing to traverse to obtain desired goods at a current business value pricing for the goods. In some examples this expected distance value is a distance friction value, wherein distances greater than the metric are likely to dissuade the consumer from making the necessary expenditure in effort or time to acquire the good at identified pricing values as a function of current demand. In one aspect the expected distance value or metric determined at 114 is a function “f(l)” of each of the determined population density locations from a desired good (“g”) as a function of the set of locations “S”, described by expression [3]:

f(l)=min_(l′)[Expected[P(l)*d(l,l′)] [3]

Wherein “l” and “l′” represent any two different locations from the population density and supply location values, and “d(l,lₚ)” is a distance metric or value of distance between “l” and “l-prime” (“lₚ”). The expression [3] determines an l-prime location (“lₚ”) that gives a minimum expected travel distance that a customer will to travel from each of the different population density forecasts (“P(l,t)”) locations “l” to obtain the good “g” at a given price point or other value, in proportion to relative differences in the population density values, to serve the greatest number of people within the aggregate of the different population density forecast locations. Thus, in one example l-prime will be closer to the location “l₁” of a first population density forecast (“P₁(l₁,t)”) that has a larger population density or occupancy (for example, a 500 seat dining venue) than the location “l₂” of another, smaller second population density forecast (“P₂(l₂,t)”) (for example, a 20-seat café), wherein the distance metric “d(l₁,lₚ)” is a fraction of the distance metric “d(l₂,lₚ)”.

At 116 the expected distance value “f(l)” is maximized to obtain at least one location point of maximal density (a maxima, “l_{M}”) that is located different respective distances from at least two of the supply site locations in proportion to differences in the population density forecasts (“P(l,t)”) for their respective locations. The locations of the maximal density points “l_{M}” best serve the highest number of people across different population density forecast locations.

At 118, if the location of the determined maximal density point “l_{M}” is not already within the set “S” of supply locations as a supply site location, then the maximal density point “_{lM}” is added to the set (“S=S+l_{M}”). This process is iteratively repeated until a threshold number of supply locations is satisfied at 119, wherein the set is completed.

At 120 a geographic distribution zone within a given geographic area is defined as a function of the set of the supply locations. In some aspects the distribution zone is defined by one or more pre-defined areas that fit the distribution of supply locations, for example zip codes or census tracts within an urban area, and still other zone identification criteria may be practiced. In aspect, for locations (“lₛ”) of each of the supply locations “s” the distribution zone comprises an area that satisfies expression [4]:

Expected[P(l)*d(l,lₛ)]<Expected[P(l)*d(l,sₚ)] [4]

At 122 the different population density forecasts (“P(l,t)”) are integrated over the distribution zone to generate spatial population integral values for location points within the geographic distribution zone area. In some aspects this may be notated as “Q(l,t)”.

At 124 the different attendance predictions of each of the different events occurring over the time period population are integrated over the time period to generate event state population integral values for the location points within the geographic distribution zone area. In some aspects this may be notated as “E(l,t)”. For example, for one day (24-hour) time period the occupancy of a 500 seat dining venue at location “l₁” may reach capacity during a sold-out performance of a musical act scheduled between 9 PM and 11 PM, but average 50% of capacity during lunch hours (from 1100 AM to 1 PM) and 35% of capacity for the other remaining business hours on that same day. In contrast, the attendance forecast at the location “l₂” of a 20-seat café venue over that same day may vary from full (100%) during certain breakfast hours (for example, 7 AM to 9 AM) and lunch hours (11 AM to 1 PM), drop to 50% during other daylight hours, and then to 35% during evening hours.

At 126 population densities are defined for the geographic distribution zone area location points as combinations of the spatial population integral values and the event state population integral values for those location points within the distribution zone. In one aspect the combination for a location “l” is a tuple (a finite order of elements) of the spatial population integral value (“Q(l,t)”) and the event state population integral value (“E(l,t)” that is expressed as <(“E(l,t),Q(l,t)>.”

At 128 units of the desired goods are dynamically allocated (placed, deployed, etc.) within the supply locations closest to the maximal density points determined (at 116 above) for the dynamic population distributions during the event state time period, namely for the distributions defined by the combinations of the spatial population integral value and the event state population integral value. Thus, in one aspect the one or more of the supply sites (“sₙ”) are selected for allocation of goods that are located a distance that is less than or equal to the determined maximal density point “l_{M}” from locations within the distribution zone that have threshold (for example, highest) values of the “<(“E(l,t),Q(l,t)>” tuple of the spatial population integral value (“Q(l,t)”) and the event state population integral value (“E(l,t),” wherein the goods are allocated to the selected sites for offering to consumers during an allocation time period corresponding to the threshold values of the “<(“E(l,t),Q(l,t)>” tuple.

Thus, aspects determine expected distance value that indicates the distance consumers within the population density locations are willing to traverse to obtain the desired good, and maximize distribution of goods in compliance with the expected distance values to obtain maximal density point locations that best serve the highest numbers of people across different population density forecast locations.

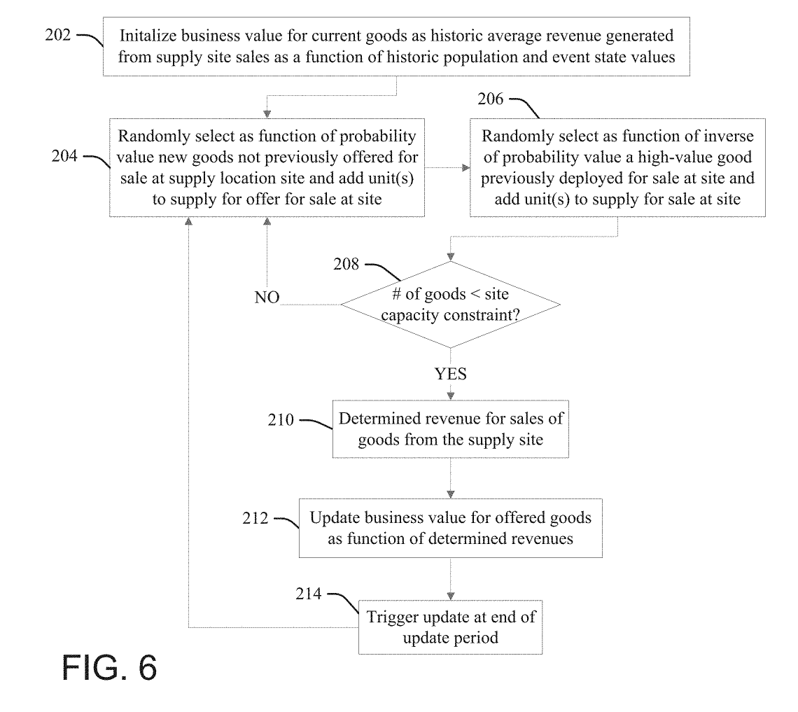

FIG. 6 illustrates an alternative embodiment of the present invention wherein business values for goods are determined as a function of numbers of different units placed at the set of supply sites, and in some examples as a function of applicable supply base capacity constraints for their respective locations. More particularly, supply sites may offer a plurality of different goods for sale, and the present aspect adjusts quantities and value of the different goods offered for sale in an iterative process that automatically adjusts stocking levels to bias inventory levels at a site to maximize revenues.

Thus, at 202 the business values of current goods of interest (“g₁”) offered for sales from a set (“G”) of “n” goods offered for sale (“G={g₁,g₂,g₃, . . . ,gₙ}”) is initialized from historic average revenue generated from sales of the good at the supply site as a function of contemporaneous population and the event state value. The business values represent value to the consumers present within the consumer population density forecasts at current pricing. The historic average revenue is determined for the good per unit time period, for example for the time period “t” that encompasses the events defining the event state population integral value (“E(l,t)”). The process at 202 establishes historic baseline sales trends for the good during similar times (for example, past Saturday evenings in the summer) at the location during similar population densities influenced by similar events (for example, when concerts were scheduled at a nearby concert hall.) In one example the business value (“V”) of a first good is expressed as “V_{gl}(e,q,a),” wherein “e” is a value of the event state at the supply site location at a given time (and which may be determined from a prior iteration of the population integral function (“E(l,t)”); “q” is a value of the spatial population distribution observed encompassing the site at that time and (and which may be determined from a prior iteration of the integral function (“Q(l,t)”)); and “a” is the number of units (or value, volume or other measurement metric) of the first good located at the supply site location.

At 204 an exploration step or process randomly selects new goods that have not been offered for sale previously at the site as a function of a probability value (“p(t)”), and adds at least one unit of the selected new goods to the supply of goods offered for sale at the supply location.

At 206 an exploitation step or process optimizing action randomly selects as a function of an inverse of the probability value (“(1−ρ(t)”) high-value goods which are known (observed) to yield high revenue returns when offered for sale in the supply site (or elsewhere) in the historic baseline sales trends under the current event state data (environmental conditions, etc.), and adds at least one unit of the high-value goods to the supply of goods offered for sale at the supply location.

The steps 204 and 206 are repeated until at 208 a supply base capacity constraint (“C(l)”) is reached for the supply site. The constraint may be defined for one or more goods of interest, or for combinations of all goods at the site, thus in response to quantities of all goods that are also located within the supply site at any given time, and wherein the supply site is limited as to an aggregate number of goods, volume of goods, or aggregate values of goods that may be located at any one time within the site.

At 210 revenue for sales of goods from the supply site is determined or otherwise observed after the unit additions executed at 204 and 206, which may be notated in one example as (“rₛ(t)”)

At 212 the business values for the good offered for sale of interest are updated with the revenues determined at 210. In one example this is determined by expression [5]:

V_{gl}(e,q,a)<-KV_{gl}(e,q,a)+(l−K)rₛ(t) [5]

Where “K” is a non-integer cost value factor that is greater than zero but less than one and that is selected to represent a future value of revenue for the goods or some other valuation metric specified by a user.

At 214 the exploration and exploitation steps 204 and 206 and subsequent steps are iteratively updated and repeated on a periodic basis. In one illustrative but not exhaustive example the periodic basis is weekly, according to expression [6]:

ρ(t)<−1/(week(t))̂2

Accordingly, the number of units of goods stocked and offered for sale at the site are used to determined maximal business values for the goods (“V_{g}(e,q,a)”) from the sales revenues realized at 210, which results in automatic re-allocations to maximize revenues in correspondence to the tuple combination state “<E(t), Q(t)>” for the site.

More particularly, the “exploration” step 204 enables selection of new products which have no historic or observed revenue data. By selecting such products and offering them at the supply site over different environmental conditions (that its, over different event state population integral values (E(l,t)), the present embodiment enables exploration of revenue space into unknown territories. This leads to identification of previously unknown opportunities for higher revenue potential that may be realized by the introduction of new goods.

The “exploitation” process step 206 enables selection of those products which are already known (observed) to yield higher return under the given environmental conditions. By selecting and adding units of such goods that are demonstrated to historically yield high revenue returns, the user has proportional expectations in realizing higher revenue via future consumer engagements at the supply site.

The revenue data obtained at 210 is used at 212 to valuing both the new and the high-value goods and products at any time. For the known, high-value products the process updates and refines business values already learnt with respect to expected revenue yield under the given event state population integral value (E(l,t)) representing current environmental conditions. For the new product additions business valuations are newly obtained, as there is no prior knowledge with respect to revenue yield under the current event state conditions.

The probability value “ρ(t)” is set to control the rate at which a user explores the revenue space at any time. As time progresses and more data is acquired, and the business values and relationships of supply to generated revenue is learned with confidence, and thus the probability rate “ρ(t)” is lowered to minimize the “exploration” function and instead maximize the “exploitation” of higher-value goods at 206. Reducing the probability rate “ρ(t)” to zero will cancel the selection and addition of new goods at 204. The probability rate “ρ(t)” is indirectly related to the exploitation function because if the space is large or there are too many environmental variables, then the exploration rate will decay more slowly as more time is needed to explore.

Allocations of goods supplies may be made periodically, though supply chain capabilities such as delivery vehicle schedules may result in other re-supply times. Sales may be monitored remotely using communication infrastructures deployed between supply units and centralized sales monitoring devices.

Thus, aspects according to the present invention provide for effective vending machine management in view of space constraints. For example, a vending machine with very limited space (10 items) may have the capability to stock many more types and kinds of items. The process and system of FIG. 6 determines which ten items have the highest business value (“V_{g}i(e,q,a)”) of all possible items for the next restocking time period, as a function of the combination spatial population and event state integral tuple for the location of the machine for that time period.

The selections and amounts of goods provided at one site may be quickly altered via the process of FIG. 6 in response to event state changes. For example, the tuple data may indicate that the machine is located at a maximal density point “l_{M}” location for sun hats for high densities of customers now heading to an outdoor assembly event location during a “sunny day” weather event within the distribution zone. This solves problems in the prior art with respect to timely deciding which items to stock, and in what quantities, in order to maximize return (business value V_{gl}(e,q,a)) relative to other possible items. By dynamically responding to rapidly changing population densities and event flows, aspects of the present invention avoid mismatches between demand and supply that are not solved by merely stocking items that are expected to yield highest returns under non-specific conditions. Instead, items which have never been tried before may be identified and timely provided to meet demand engendered by current sets of environmental conditions or other attributes unique to the event state.

One example implementation of the present invention is configured to engage customer vehicles via their unique customer and vehicle identification indicia. Thus, a device according to the present invention sends a text message to a retailer device with values that include a customer's vehicle license plate or toll booth pass transmitter for a toll payment account of the customer, and a product ID of a product of interest. The vehicle license plate or toll booth pass transmitter is identified and a vending machine that has a maximal density point “l_{M}” location relative to a current (or projected future) location of the vehicle dispenses the desired product for the customer to pick up on the go; the customer may quickly drive up to the vending machine and obtain the good, and in some examples automatically charge his or her toll payment account via wireless communication engagement with the toll booth pass transmitter for the required purchase amount. “Distance friction” factors associated with the sale are reduced by reducing both travel distance and time required for the customer to physically retrieve the good from a current location and execute the sales transaction, enabling a reduction of the perceived transactions costs for this consumer to a point below the pricing valuation and thereby enabling the sale.

In another example, a rain storm event occurring while a customer is en-route and driving to a restaurant is incorporated within the event state value of the combination tuple. The customer realizes that he or she will need to walk a substantial distance in the rain to enter the destination restaurant from a parking space once the car is parked, and the customer does not have an umbrella. Under the prior art the distance friction associated with the time and effort required to make another stop on the way to buy an umbrella will likely diminish the value of the umbrella and discourage the purchase of the umbrella, wherein the customer foregoes the purchase and elects to instead endure the inconvenience of running through the rain from the parked car to the restaurant. This choice is made as this inconvenience is not perceived to outweigh the cost of the prior art umbrella purchase transaction when the distance friction is take into account by the consumer.

In contrast, aspects of the present invention identify a umbrella supply site having a maximal density point “l_{M}” location for sales of umbrellas as a function of the combination tuple of the spatial population integral values (indicating that high densities of customers are heading to an outdoor assembly event location within the distribution zone) and the event state (current rainstorm event projected to persist for the next two hours, thus spanning the assembly event). Aspects may broadcast general advertisements and/or direct communicate alerts to the customer (via a text or other alert on a cellular phone or other personal digital assistant (PDA) device of the customer) that convey the locations of maximal density point “l_{M}” supply sites and inform the consumer of an appropriate pricing as determined from the business values derived from historic revenues aligned with the combination tuple data. In one example the notice to the consumer state “umbrellas available for pick up at automated umbrella kiosk in one mile for $X using your wireless toll pass account device”. The location of the kiosk and the rapid purchase mechanism enabled thus reduces the distance friction to the point that the communicated price is a good value for the demand or need of the customer, wherein the value outweighs the unpleasant inconveniences caused by foregoing the purchase, and thereby induces the customer to stop and buy the umbrella.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for selective location of supply amounts based on dynamic population density and travel distance metrics, comprising executing on a computer processor the steps of:
determining consumer population density forecasts for each of a plurality of different geographic locations as functions of different distances to each of a plurality of different events occurring during a time period of duration of the events, wherein each of the events have different population amounts and geographic population locations;
identifying geographic locations of each of plurality of different supply sites for goods desired by consumers within the events population amounts, wherein each supply site has a different geographic location;
determining a geographic maximal density location point between geographic locations of first and second ones of the plurality of different events that is located at different distances from the locations of the first event and the second event as a function of differences in the consumer population density forecasts for the location of the first event and the location of the second event, wherein the maximal density location point is located closer to a one of the first event and the second event that has a higher consumer population density forecast for its location; and
allocating a quantity of the goods to a one of the plurality of supply sites that is located at the maximal density location point, in an amount selected to maximize a business value of the goods as a function of a population distribution of the maximal density location point.

2. The method of claim 1, further comprising:
integrating computer-readable program code into a computer system comprising the processor, a computer readable memory in circuit communication with the processor, and a computer readable storage medium in circuit communication with the processor; and
wherein the processor executes program code instructions stored on the computer-readable storage medium via the computer readable memory and thereby performs the steps of determining the consumer population density forecasts for the plurality of different geographic locations, identifying the geographic locations of the plurality of different supply sites, determining the geographic maximal density location point, and allocating the quantity of the goods to the supply site located at the maximal density location point and in the amount selected to maximize the business value of the goods as the function of the population distribution of the maximal density location point.

3. The method of claim 1, further comprising:
determining an expected distance value that the consumers within the events population amounts are willing to traverse to obtain the goods at a current business value pricing of the goods; and
determining the maximal density location point as within the expected distance value to the location of the first event that has the higher consumer population density forecast.

4. The method of claim 1, further comprising:
in response to determining that none of the identified geographic locations of the different supply sites comprise the maximal density location point as their geographic locations, adding a new supply site that comprises the maximal density location point as its geographic location to the plurality of supply sites.

5. The method of claim 1, further comprising:
determining an integral of the determined consumer population density forecast values over a geographic distribution zone area that encompasses the different geographic locations of the different population density forecasts to generate a spatial population integral values for location points within the geographic distribution zone area;
determining an integral of the different attendance prediction values for each of the different events occurring over the time period population to generate event state population integral values for the location points within the geographic distribution zone area; and
defining the population distribution of the maximal density location point as a combination of the spatial population integral value and the event state population integral value for the maximal density location point.

6. The method of claim 5, wherein the combination of the spatial population integral values and the event state population integral values is a combination tuple of the spatial population integral value and the event state population integral value for the maximal density location point.

7. The method of claim 6, further comprising:
determining the business values maximized for each of first goods and second goods that are different from each other and are allocated to the supply site located at the maximal density location point as functions of revenue sales generated by the quantities supplied to the supply site located at the maximal density location point.

8. The method of claim 7, further comprising:
selecting new goods with no historic revenue data at a probability rate and adding a unit of the new goods to the supplies of the supply site located at the maximal density location point that are offered for sale;
selecting high-value goods with historic revenue data at an inverse of the probability rate and adding a unit of the high-value goods to the supplies of the supply site located at the maximal density location point that are offered for sale;
determining revenue realized from offers for sale of goods including the added units of the new goods and the high-value goods from the supply site located at the maximal density location point; and
updating a determined business value for the high-value goods and determining a business value for the new goods as a function of the revenue realized from the offers for sale of goods including the added units of the new goods and the high-value goods from the supply site located at the maximal density location point, and as a function of the combination tuple of the spatial population integral value and the event state population integral value for the maximal density location point.

9. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
determines consumer population density forecasts for each of a plurality of different geographic locations as functions of different distances to each of a plurality of different events occurring during a time period of duration of the events, wherein each of the events have different population amounts and geographic population locations;
identifies geographic locations of each of plurality of different supply sites for goods desired by consumers within the events population amounts, wherein each supply site has a different geographic location;
determines a geographic maximal density location point between geographic locations of first and second ones of the plurality of different events that is located at different distances from the locations of the first event and the second event as a function of differences in the consumer population density forecasts for the location of the first event and the location of the second event, wherein the maximal density location point is located closer to a one of the first event and the second event that has a higher consumer population density forecast for its location; and
allocates a quantity of the goods to a one of the plurality of supply sites that is located at the maximal density location point, in an amount selected to maximize a business value of the goods as a function of a population distribution of the maximal density location point.

10. The system of claim 9, wherein the processor executes the program instructions stored on the computer-readable storage medium via the computer readable memory and thereby:
determines an expected distance value that the consumers within the events population amounts are willing to traverse to obtain the goods at a current business value pricing of the goods; and
determines the maximal density location point as within the expected distance value to the location of the first event that has the higher consumer population density forecast.

11. The system of claim 9, wherein the processor executes the program instructions stored on the computer-readable storage medium via the computer readable memory and thereby:
determines an integral of the determined consumer population density forecast values over a geographic distribution zone area that encompasses the different geographic locations of the different population density forecasts to generate a spatial population integral values for location points within the geographic distribution zone area;
determines an integral of the different attendance prediction values for each of the different events occurring over the time period population to generate event state population integral values for the location points within the geographic distribution zone area; and
defines the population distribution of the maximal density location point as a combination of the spatial population integral value and the event state population integral value for the maximal density location point.

12. The system of claim 11, wherein the combination of the spatial population integral values and the event state population integral values is a combination tuple of the spatial population integral value and the event state population integral value for the maximal density location point.

13. The system of claim 12, wherein the processor executes the program instructions stored on the computer-readable storage medium via the computer readable memory and thereby determines the business values maximized for each of first goods and second goods that are different from each other and are allocated to the supply site located at the maximal density location point as functions of revenue sales generated by the quantities supplied to the supply site located at the maximal density location point.

14. The system of claim 13, wherein the processor executes the program instructions stored on the computer-readable storage medium via the computer readable memory and thereby:
selects new goods with no historic revenue data at a probability rate and adds a unit of the new goods to the supplies of the supply site located at the maximal density location point that are offered for sale;
selects high-value goods with historic revenue data at an inverse of the probability rate and adds a unit of the high-value goods to the supplies of the supply site located at the maximal density location point that are offered for sale;
determines revenue realized from offers for sale of goods including the added units of the new goods and the high-value goods from the supply site located at the maximal density location point; and
updates a determined business value for the high-value goods and determines a business value for the new goods as a function of the revenue realized from the offers for sale of goods including the added units of the new goods and the high-value goods from the supply site located at the maximal density location point, and as a function of the combination tuple of the spatial population integral value and the event state population integral value for the maximal density location point.

15. The system of claim 14, wherein the program instructions stored on the computer-readable storage medium are provided as a service in a cloud environment.

16. A computer program product for selective location of supply amounts based on dynamic population density and travel distance metrics, comprising:
a computer readable storage medium having computer readable program code embodied therewith, wherein the computer readable storage medium is not a transitory signal per se, the computer readable program code comprising instructions for execution by a processor that cause the processor to:
determine consumer population density forecasts for each of a plurality of different geographic locations as functions of different distances to each of a plurality of different events occurring during a time period of duration of the events, wherein each of the events have different population amounts and geographic population locations;
identify geographic locations of each of plurality of different supply sites for goods desired by consumers within the events population amounts, wherein each supply site has a different geographic location;
determine a geographic maximal density location point between geographic locations of first and second ones of the plurality of different events that is located at different distances from the locations of the first event and the second event as a function of differences in the consumer population density forecasts for the location of the first event and the location of the second event, wherein the maximal density location point is located closer to a one of the first event and the second event that has a higher consumer population density forecast for its location;
in response to determining that none of the identified geographic locations of the different supply sites comprise the maximal density location point as their geographic locations, add a new supply site that comprises the maximal density location point as its geographic location to the plurality of supply sites; and
allocate a quantity of the goods to the supply site of the plurality of supply sites that is located at the maximal density location point in an amount selected to maximize a business value of the goods as a function of a population distribution of the maximal density location point.

17. The computer program product of claim 16, wherein the computer readable program code instructions for execution by the processor further cause the processor to:
determine an expected distance value that the consumers within the events population amounts are willing to traverse to obtain the goods at a current business value pricing of the goods; and
determine the maximal density location point as within the expected distance value to the location of the first event that has the higher consumer population density forecast.

18. The computer program product of claim 17, wherein the computer readable program code instructions for execution by the processor further cause the processor to:
determine an integral of the determined consumer population density forecast values over a geographic distribution zone area that encompasses the different geographic locations of the different population density forecasts to generate a spatial population integral values for location points within the geographic distribution zone area;
determine an integral of the different attendance prediction values for each of the different events occurring over the time period population to generate event state population integral values for the location points within the geographic distribution zone area; and
define the population distribution of the maximal density location point as a combination of the spatial population integral value and the event state population integral value for the maximal density location point.

19. The computer program product of claim 18, wherein the combination of the spatial population integral values and the event state population integral values is a combination tuple of the spatial population integral value and the event state population integral value for the maximal density location point.

20. The computer program product of claim 19, wherein the computer readable program code instructions for execution by the processor further cause the processor to determine the business values maximized for each of first goods and second goods that are different from each other and are allocated to the supply site located at the maximal density location point as functions of revenue sales generated by the quantities supplied to the supply site located at the maximal density location point.
